(19) United States
(12) Patent Application Publication
(10) Pub. No.: US 2018/0200734 A1
(43) Pub. Date: Jul. 19, 2018

(54) Method And Apparatus For Desublimation Prevention In A Direct Contact Heat Exchanger

(71) Applicants: Larry Baxter, Orem, UT (US); Aaron Sayre, Spanish Fork, UT (US); David Frankman, Provo, UT (US); Kyler Stitt, Lindon, UT (US); Nathan Davis, Bountiful, UT (US); Christoper Bence, Tigard, OR (US)

(72) Inventors: Larry Baxter, Orem, UT (US); Aaron Sayre, Spanish Fork, UT (US); David Frankman, Provo, UT (US); Kyler Stitt, Lindon, UT (US); Nathan Davis, Bountiful, UT (US); Christoper Bence, Tigard, OR (US)

(21) Appl. No.: 15/406,863

(22) Filed: Jan. 16, 2017

(51) Int. Cl. B05B 1/00; F28C 1/00; B05B 1/18; B01D 3/18; B01J 4/00

(52) U.S. Cl. CPC B05B 1/005; F28C 1/00; B01J 4/001; B01D 3/18; B05B 1/18

(57) ABSTRACT

A method and device are disclosed herein for distributing a gas into a vessel. The method comprises providing a gas distribution apparatus, wherein an exposed surface of the apparatus comprises a material that inhibits adsorption of the gas and deposition of the gas' solid form. The material chosen is chemically repulsive to the gas and the gas' solid form. In this manner, desublimation of the gas and deposition of the gas' solid form onto the exposed surface is prevented. The device disclosed herein is the gas distribution apparatus referenced above.

This invention was made with government support under DE-FE0028697 awarded by The Department of Energy. The government has certain rights in the invention.

### BACKGROUND

Field of the Invention

This invention relates generally to the field of gas/liquid heat exchange. Our immediate interest is in the prevention of desublimation of carbon dioxide gas onto gas distributors in cryogenic exchangers, but this process has much broader application.

Related Technology

As cold processing technology becomes more prevalent, new methods of conducting heat and material exchange in cryogenic systems are needed.

The art of distributing gases into vessels has been present since time immemorial. Distributing gases through cryogenic liquids and other low temperature applications, a more recent development, is also common today. However, the gases used, such as nitrogen at atmospheric pressures, behave very differently than other gases, such as carbon dioxide, sulfur dioxide, and nitrogen dioxide. When these latter gases are at near ambient pressure and cryogenic temperatures, the gas can easily go directly from gas to solid (desublimation). Traditional gas distributors can ice over as the gas directly desublimates onto the surface of the bubbler or desublimated solid material deposits onto the distributor, blocking the openings. This includes the various types of plates, trays, nozzles, and spargers used traditionally for vessels such as direct-contact heat exchangers, direct-contact material exchangers, spray towers, reactors, combustors, distillation columns, flash vessels, and tanks. In general, a gas distributor is any device that provides an interface between a gas and another chamber or vessel. The gas distributor allows the gas to pass into a liquid, a suspension of solids, or a different gas.

The extreme cold conditions these systems exist at also tend to bias suppliers of distributors towards metals, as they are more resistant to temperature cycling than most common materials. Standard techniques at ambient pressure and cryogenic temperatures lead to desublimation, blocking the systems. A gas distributor made of metal or other porous materials will ice over at these pressures and temperatures, and the process of gas distribution will be halted. No current techniques can prevent the desublimation of gases onto cryogenic distributors, nor address this issue in distributing gas to a vessel.

United States patent publication number 2010/0018248 to Northrop et al. teaches a cryogenic distillation tower. This disclosure is pertinent and could benefit from gas distribution methods disclosed herein and is hereby incorporated by reference in its entirety for all that it teaches.

United States patent publication number 2012/0079852 to Northrop et al. teaches systems and methods for removing hydrocarbons and acid gases from a hydrocarbon gas. This disclosure is pertinent and could benefit from gas distribution methods disclosed herein and is hereby incorporated by reference in its entirety for all that it teaches.

United States patent publication numbers 2012/0031144 and 2012/0079852 to Northrop et al. teaches systems and methods for removing hydrocarbons and acid gases from a hydrocarbon gas. This disclosure is pertinent and could benefit from gas distribution methods disclosed herein and is hereby incorporated by reference in its entirety for all that it teaches.

United States patent publication number 2012/0125043 to Cullinane et al. teaches a cryogenic system for removing acid gases from a hydrocarbon gas stream. This disclosure is pertinent and could benefit from gas distribution methods disclosed herein and is hereby incorporated by reference in its entirety for all that it teaches.

United States patent publication number 2012/0204599 to Northrop et al. teaches a cryogenic system for removing acid gases from a hydrocarbon gas stream, with removal of hydrogen sulfide. This disclosure is pertinent and could benefit from gas distribution methods disclosed herein and is hereby incorporated by reference in its entirety for all that it teaches.

### SUMMARY OF THE INVENTION

A method is disclosed herein for distributing a gas into a vessel. This method comprises providing a gas distribution apparatus, wherein an exposed surface of the apparatus comprises a material that inhibits adsorption of the gas and deposition of the gas' solid form. The material chosen is chemically repulsive to the gas and the gas' solid form. The gas distribution apparatus contains holes within counter-sunk holes. These holes have inserts shaped to fit, and these inserts are considered the exposed surface. In this manner, desublimation of the gas and deposition of the gas' solid form onto the exposed surface is prevented.

In other embodiments of the disclosed invention, the vessel is a direct-contact heat exchanger, a direct-contact material exchanger, spray tower, reactor, combustor, distillation column, flash vessel, or tank.

In other embodiments of the disclosed invention, the vessel contains a liquid, solid particles, or a different gas than the original gas being distributed.

In other embodiments of the disclosed invention, the gas distribution apparatus is a bubble plate, bubble tray, nozzle, or sparger.

In other embodiments of the disclosed invention, the adsorption inhibition material is polytetrafluoroethylene, polychlorotrifluoroethylene, a smooth surface ceramic, natural diamond, man-made diamond, chemical-vapor deposition diamond, or polycrystalline diamond.

In other embodiments, the gas is carbon dioxide, sulfur dioxide, or nitrogen dioxide.

A device is disclosed herein for distributing a gas into a vessel. The device comprises a gas distribution apparatus, wherein an exposed surface of the apparatus comprises a material that inhibits adsorption of the gas and deposition of the gas' solid form. The material chosen is chemically repulsive to the gas and the gas' solid form. The gas distribution apparatus contains holes within counter-sunk holes. These holes have inserts shaped to fit, and these inserts are considered the exposed surface. In this manner, desublimation of the gas and deposition of the gas' solid form onto the exposed surface is prevented.

In other embodiments of the disclosed invention, the vessel is a direct-contact heat exchanger, a direct-contact material exchanger, spray tower, reactor, combustor, distillation column, flash vessel, or tank.

In other embodiments of the disclosed invention, the vessel contains a liquid, solid particles, or a different gas than the original gas being distributed.

In other embodiments of the disclosed invention, the gas distribution apparatus is a bubble plate, bubble tray, nozzle, or sparger.

In other embodiments of the disclosed invention, the adsorption inhibition material is polytetrafluoroethylene, polychlorotrifluoroethylene, a smooth surface ceramic, natural diamond, man-made diamond, chemical-vapor deposition diamond, or polycrystalline diamond.

In other embodiments, the gas is carbon dioxide, sulfur dioxide, or nitrogen dioxide.

By this device or this method, as the gas is distributed into the colder vessel, the gas may desublimate, but it has nowhere on the gas distributor to deposit. Thus, the gas does not desublimate onto the surface of the gas distributor, and the gas distributor does not become clogged by solids.

### BRIEF DESCRIPTION OF THE DRAWINGS

A more particular description of the invention briefly described above is made below by reference to specific embodiments. Several embodiments are depicted in drawings included with this application, in which:

FIGS. 1A-E depict views of various types of gas distributors, according to the claimed invention;

FIG. 2 depicts a cross-sectional view of a gas prevented from passing upwards through a gas distributor with a metal surface;

FIG. 3 depicts a cross-sectional view of embodiments of a gas distributor wherein a gas is passing upwards through a bubble tray, according to the claimed invention;

FIG. 4 depicts one embodiment a gas distributor in a typical direct contact heat exchanger, according to the claimed invention;

FIG. 5 depicts a method of using a gas distributor, according to the claimed invention.

### DETAILED DESCRIPTION

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

The descriptions of the various embodiments include, in some cases, references to elements described with regard to other embodiments. Such references are provided for convenience to the reader, and to provide efficient description and enablement of each embodiment, and are not intended to limit the elements incorporated from other embodiments to only the features described with regard to the other embodiments. Rather, each embodiment is distinct from each other embodiment. Despite this, the described embodiments do not form an exhaustive list of all potential embodiments of the claimed invention; various combinations of the described embodiments are also envisioned, and are inherent from the descriptions of the embodiments below. Additionally, embodiments not described below that meet the limitations of the claimed invention are also envisioned, as is recognized by those of skill in the art.

Throughout the detailed description, various elements are described as “off-the-shelf.” As used herein, “off-the-shelf” means “pre-manufactured” and/or “pre-assembled.”

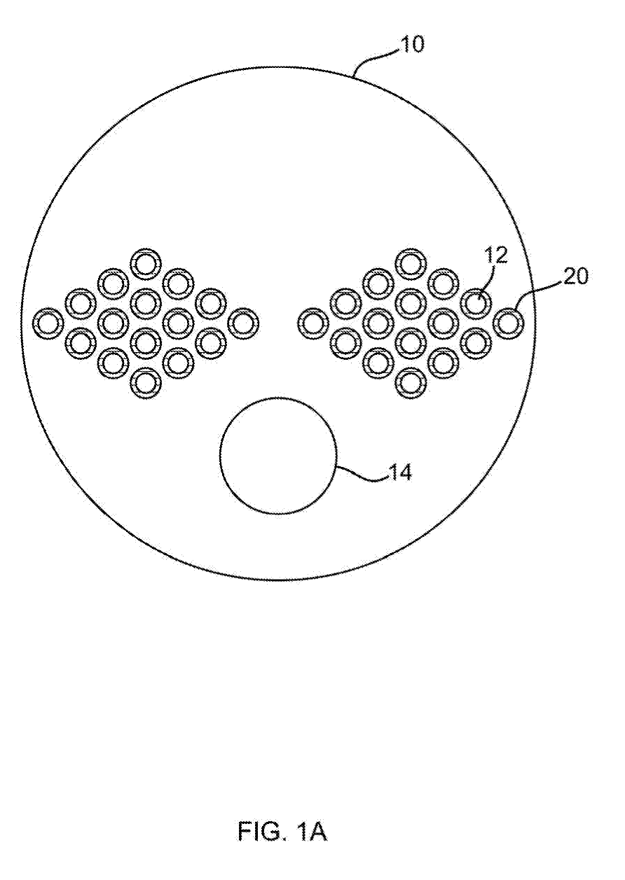

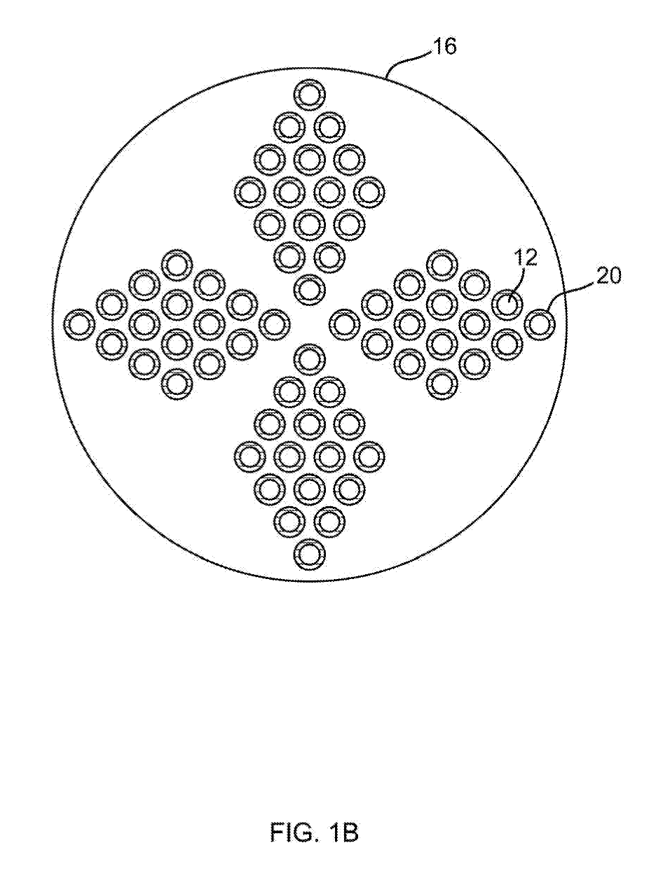

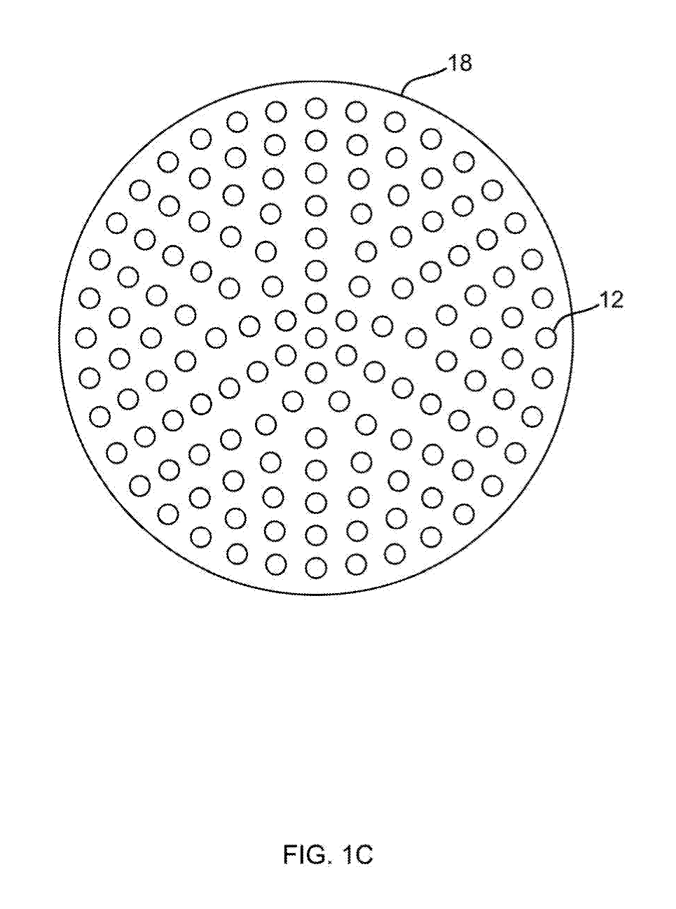

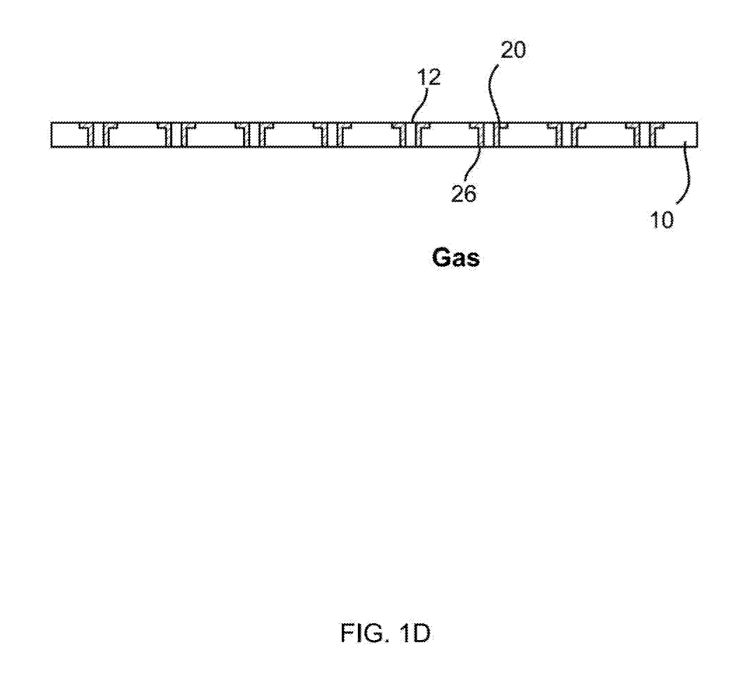

FIGS. 1A-F depict views of various types of gas distributors, according to the claimed invention. These do not represent all types of gas distributors, but are included as examples. Referring to FIG. 1A, Bubble plate 10 includes bubble holes 12 and downcomer 14. Liquid would be present above plate 10, flowing down through downcomer 14 while bubbles were coming up through bubble holes 12. In some embodiments, the fluid may form a column greater than 6″. Holes 12 form a diamond shaped groupings along a center axis of plate 10. Downcomer 14 is symmetric on the vertical axis offset from the horizontal axis containing holes 12. This arrangement may be advantageous due to the turbid flow patterns produced allowing better exchange. Holes 12 shown include a central hole that extends through the entirety of plate 10 and a counter-sunk hole that extends a few millimeters into the surface of plate 10. In some embodiments, the counter-sunk hole is 30% larger than the center hole. In this instance, the hole has an insert 20 placed into it made of a material such as polytetrafluoroethylene, polychlorotrifluoroethylene, smooth ceramics, natural diamond, man-made diamond, chemical-vapor deposition diamond, and polycrystalline diamond. Insert 20 has a hole through it that allows gas to pass through it, but the gas and the solid form of the gas are not able to deposit or desublimates onto the surface, and is thus unable to block the gas flow. Insert 20 could be attached by either having the lower portion of the outer hole threaded while the insert was threaded and attached accordingly. Alternatively, the insert could be attached with an appropriate adhesive for a cryogenic system. In some embodiments, holes 12 are counter-bore holes. Referring to FIG. 1B, Bubble plate 16 includes bubble holes 12 in a typical pattern, but does not have a downcomer. In this instance, the liquid flowing down goes around the plate, which plate is not the full diameter of the tube. Holes 12 are arranged in a symmetric diamond pattern about the center on the main axes. In some embodiments, the fluid may form a column of more than 6″. This arrangement may be advantageous due to the turbid flow patterns that interact with the edge effects of the plate as the liquid flows across and down. Referring to FIG. 1C, Bubble plate 18 includes bubble holes 12 in an evenly spaced grid pattern. In some embodiments, the fluid may form a column of more than 6″. In this instance, the liquid flowing down goes around the plate, which plate is not the full diameter of the tube. The hole pattern may be advantageous as it allows an even pattern for aerating the entire cross-section of fluid. Holes 12 are of the same counter-sunk, insert 20 containing variety shown in FIGS. 1A and 1B, but inserts 20 are not shown for clarity. In some embodiments, holes 12 are counter-bore holes. FIG. 1D shows a cross-sectional side view of bubble plate 10, showing bubble holes 12. In this instance, the liquid flows down and around plate 10 while the bubbles pass upwards through holes 12. Holes 12, as described above, are counter-sunk and insert 20 is placed inside of the non-stick material, with a hole spanning the center. The insert could be attached by either having the lower portion of the outer hole threaded while the lower portion of the insert 26 was threaded and attached accordingly. Alternatively, the insert could be attached with an appropriate adhesive for a cryogenic system. In this instance, the liquid flowing down goes around plate 10, which plate is not the full diameter of the tube. This arrangement may be advantageous as the material making up insert 20 is a non-stick material, allowing for holes 12 to not become blocked by solids while allowing for plate 10 to be made of a stronger material, such as a metal, for larger spans or greater loads. The non-stick material would be present at the most likely place for desublimation and blockage, namely, the holes, preventing blockage and allowing continuing flow. In some embodiments, holes 12 are counter-bore holes. FIG. 1E shows an isometric view of sparger 24, with bubble holes 22. In this instance, sparger 24 would be placed in the bottom of a tank and fluid would be continuously stirred around it causing any solids formed to flow away from holes 22. In general, bubble holes 12 are only limited in lower size by the structural limitations of the material of construction. Holes 22 would contain the same insert 20 as discussed above. Bubble holes 12 are 1/16″ in diameter in one embodiment of the present invention. In other embodiments, they range from 1/32″ to ¼″ in diameter. In some embodiments, bubble plates 10, 16, and 18 may have as few as 1 hole, or as many as several thousand holes.

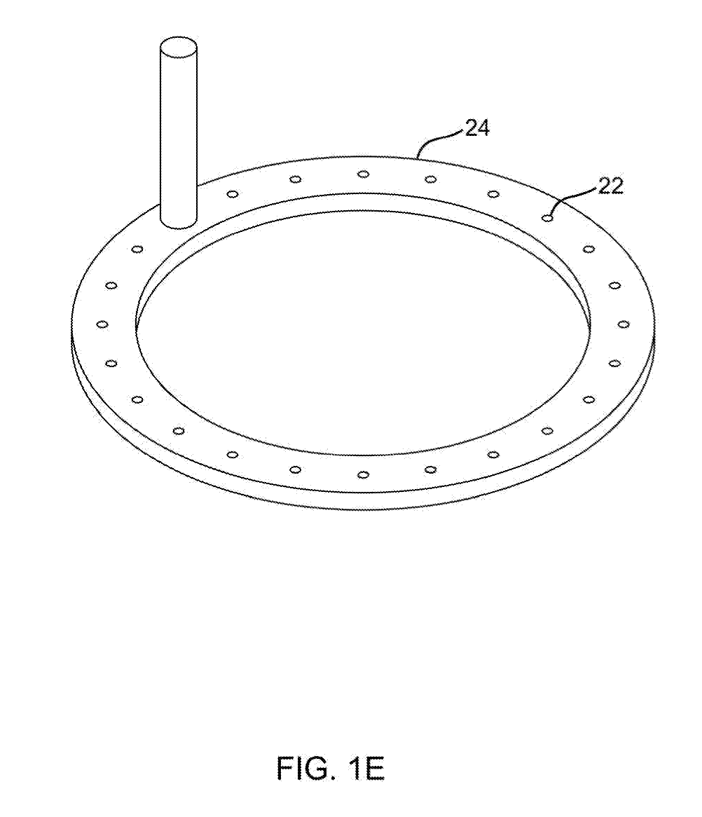

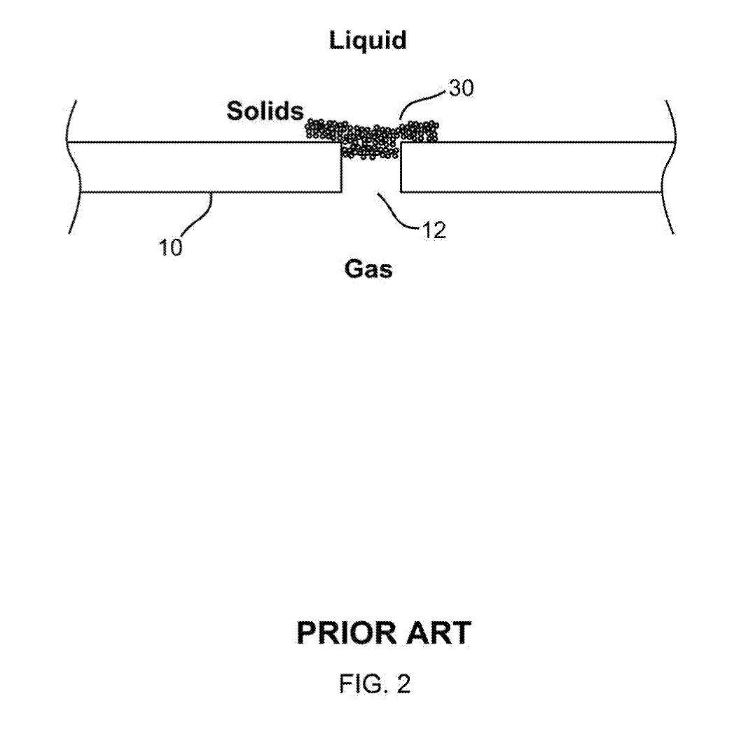

FIG. 2 depicts a cross-sectional view of a gas prevented from passing upwards through a gas distributor with right angle holes and a metal surface as in the prior art. Bubble hole 12 in bubble plate 10 is blocked by solids resulting from desublimation and deposition of gases onto the metal surface.

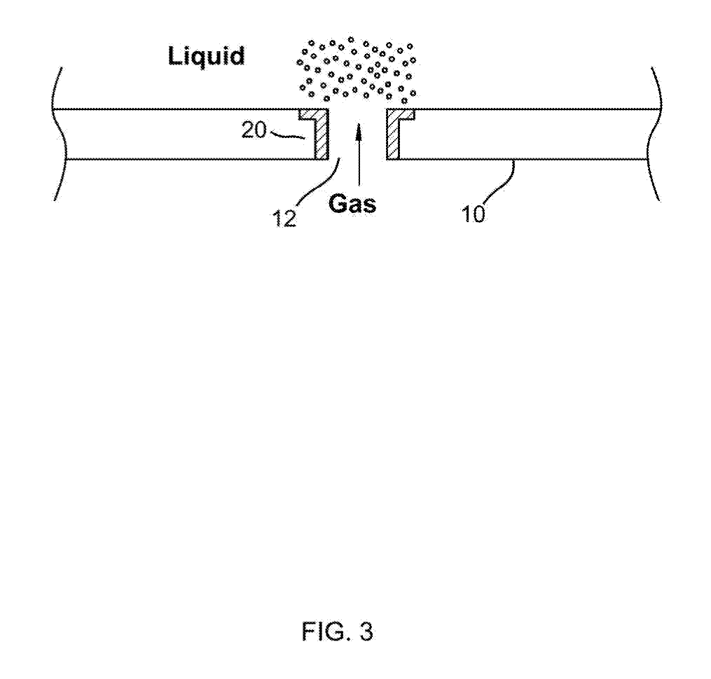

FIG. 3 depicts a cross-sectional view of one embodiment of the gas distributor wherein a gas is passing upwards through a bubble tray, according to the claimed invention. In both figures, bubble hole 12 in bubble plate 10 is unrestricted since the gas is inhibited in adsorbing or sublimating onto the surface material of the insert 20 placed in holes 12, and the solid form of the gas is inhibited from depositing onto the same surface material. The surface material may consist of polytetrafluoroethylene, polychlorotrifluoroethylene, smooth ceramics, natural diamond, man-made diamond, chemical-vapor deposition diamond, and polycrystalline diamond. In this instance, holes 12 consist of a counter-sunk hole with insert 20 made of the required surface material, with a hole for the gas to pass through, as discussed above. The balance of plate 10 is made of a more structurally rigid material. In one embodiment of the present invention, the temperature of the material in the vessel is lower than the sublimation temperature of the gas. In some embodiments, holes 12 are counter-bore holes.

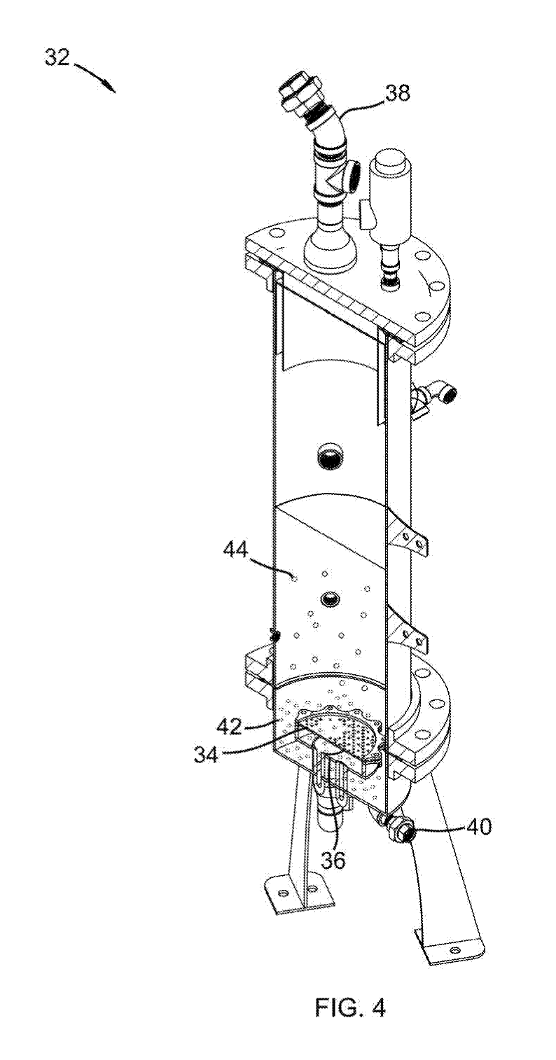

FIG. 4 a depicts a cross-sectional view of one embodiment of a gas distributor in a typical direct contact heat exchanger, according to the claimed invention. Column 32 has liquid entering through inlet 38. This downcoming liquid passes across bubble plate 34 which is placed over gas feed chamber 36. The gas bubbles 40 enter into the liquid stream and are drawn away from the plates and around gas feed chamber 36. The gas may still sublimate in the liquid as a type of snow 42, but this material does not stick to or block the bubble plate and is drawn into the area below gas feed chamber 36 and out of column outlet 40. In some instances, the bottom of the body of gas feed chamber 36 is more than 3″ above the bottom of column 32. In some instances, the liquid level may be as little as 6″ above bubble plate 34. The arrangement of gas feed chamber 36 being above the bottom of the column may be advantageous as it draws the liquid that has contacted the gas down and away from the plate towards outlet 44. Further, as the plate is non-stick to the gas and the solid form of the gas, the drawing away of the material prevents any stagnant zones from forming above the bubble plate. Further, the agitation causes the lower portion of the column to not develop solids build up in stagnant zones.

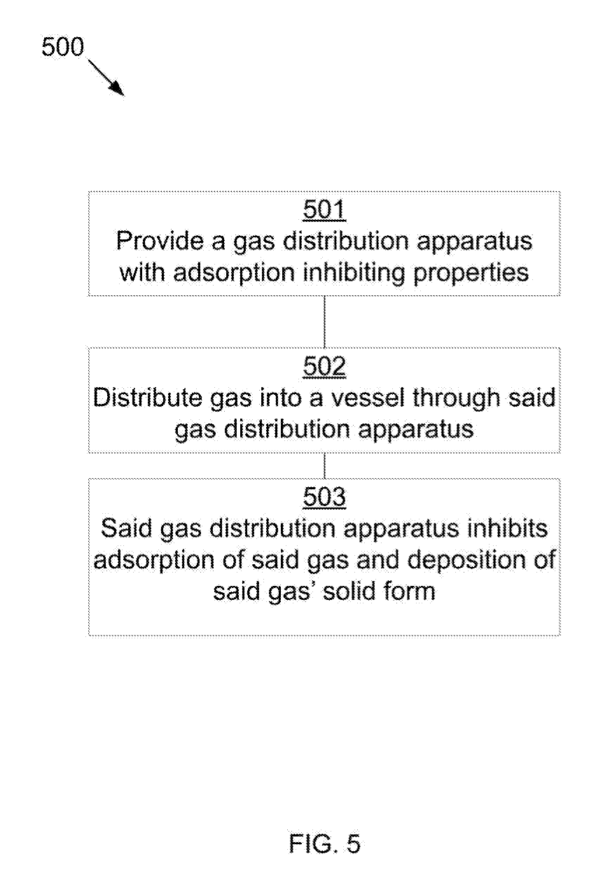

FIG. 5 depicts a method of using a gas distributor, according to one embodiment of the claimed invention. The method 500 comprises providing a gas distributor for distributing gas into a vessel 501, wherein a part of the surface of the gas distributor exposed to the gas comprises a material that inhibits adsorption of gas by desublimation or deposition of solid forms of the gas. The adsorption inhibition material is comprised of a substance chemically repulsive to the gas and solid forms of the gas being distributed, such as polytetrafluoroethylene, polychlorotrifluoroethylene, smooth ceramics, natural diamond, man-made diamond, chemical-vapor deposition diamond, or polycrystalline diamond. The holes through the gas distributor include a central hole that extends through the entirety of the gas distributor and a counter-sunk hole that extends a few millimeters into the surface of the gas distributor. In this instance, the hole has an insert placed into it made of the adsorption inhibition material. This insert has a hole through it that allows gas to pass through it, but the gas and the solid gas is not able to deposit or desublimates onto the surface, and is thus unable to block the gas flow. The insert is the part of the surface that inhibits blockage. Therefore, as the gas is distributed into the vessel 502, gas desublimation onto the gas distributor is prevented and the gas distributor is not blocked by solids 503. In some embodiments, the holes are counter-bore holes.

While the surface material is specifically mentioned, this does not limit the material that comprises the structure of the device. The interior of the device may be the same as the surface, or it may be a different material, such as a metal. Further, the material may coat the entire surface of the device, or only the parts of the surface exposed directly to gas, namely the holes and the area immediately around the holes.

In some embodiments of the claimed invention, the gas is carbon dioxide, sulfur dioxide, nitrogen dioxide, or other gases that can desublimate at cryogenic temperatures.

The bubbling apparatus can be a bubble tray, plate, nozzle, sparger, or similar apparatus used for bubbling gases into a liquid.

In some embodiments of the claimed invention, the gas distributor is located in a direct-contact heat exchanger, direct-contact material exchanger, spray tower, reactor, combustor, distillation column, flash vessel, or tank.

In some embodiments of the claimed invention, the vessel contains a liquid.

In some embodiments of the claimed invention, the liquid in the vessel is a typical cryogenic heat exchange fluid.

In some embodiments of the claimed invention, the vessel contains a suspended solid.

In some embodiments of the claimed invention, the vessel contains a different gas than the gas fed from the distributor.

We claim:

1. A method for distributing a gas into a vessel; the method comprising:
providing a gas distribution apparatus, wherein an exposed surface of said apparatus comprises a material that inhibits adsorption of said gas and deposition of said gas' solid form;
said material being chemically repulsive to said gas and said gas' solid form; and,
said gas distribution apparatus containing counter-sunk holes with an insert shaped to fit said counter-sunk hole and wherein said inserts have a hole through the center of said insert allowing for said gas to pass through said gas distribution apparatus; and,
wherein said exposed surface of said apparatus consists of said insert;
whereby desublimation of said gas and deposition of said gas' solid form onto said exposed surface is prevented.

2. The method of claim 1, wherein said vessel is selected from the group consisting of direct-contact heat exchangers, direct-contact material exchangers, spray towers, reactors, combustors, distillation columns, flash vessels, and tanks.

3. The method of claim 2, wherein said gas is distributed into said vessel, wherein said vessel contains a liquid.

4. The method of claim 2, wherein said gas is distributed into said vessel, wherein said vessel contains solid particles suspended in a different gas.

5. The method of claim 2, wherein said gas is distributed into said vessel, wherein said vessel contains a different gas.

6. The method of claim 1, wherein said gas distribution apparatus is selected from the group consisting of bubble plates, bubble trays, nozzles, and spargers.

7. The method of claim 1, wherein said adsorption inhibition material is selected from the group consisting of polytetrafluoroethylene, polychlorotrifluoroethylene, smooth ceramics, natural diamond, man-made diamond, chemical-vapor deposition diamond, and polycrystalline diamond.

9. The method of claim 1, wherein said gas is selected from the group consisting of carbon dioxide, sulfur dioxide, and nitrogen dioxide.

10. A device for distributing a gas into a vessel; the device comprising:
a gas distribution apparatus, wherein an exposed surface of said apparatus comprises a material that inhibits adsorption of said gas and deposition of said gas' solid form;
said material being chemically repulsive to said gas and said gas' solid form;
said gas distribution apparatus containing holes with an insert shaped to fit said hole and wherein said inserts have a hole through the center of said insert allowing for said gas to pass through said gas distribution apparatus, wherein said holes are chosen from the group consisting of counter-sunk holes and counter-bore holes; and,
wherein said exposed surface of said apparatus consists of said insert;
whereby desublimation of said gas and deposition of said gas' solid form onto said exposed surface is prevented.

11. The device of claim 10, wherein said vessel is selected from the group consisting of direct-contact heat exchangers, direct-contact material exchangers, spray towers, reactors, combustors, distillation columns, flash vessels, and tanks.

12. The device of claim 11, wherein said gas is distributed into said vessel, wherein said vessel contains a liquid.

13. The device of claim 11, wherein said gas is distributed into said vessel, wherein said vessel contains solid particles suspended in a different gas.

14. The device of claim 11, wherein said gas is distributed into said vessel, wherein said vessel contains a different gas.

15. The device of claim 10, wherein said gas distribution apparatus is selected from the group consisting of bubble plates, bubble trays, nozzles, and spargers.

16. The device of claim 10, wherein said adsorption inhibition material is selected from the group consisting of polytetrafluoroethylene, polychlorotrifluoroethylene, smooth ceramics, natural diamond, man-made diamond, chemical-vapor deposition diamond, and polycrystalline diamond.

18. The device of claim 10, wherein said gas is selected from the group consisting of carbon dioxide, sulfur dioxide, and nitrogen dioxide.
